(19) United States
(12) Patent Application Publication
(10) Pub. No.: US 2024/0291198 A1
(43) Pub. Date: Aug. 29, 2024

(54) VARIABLY POSITIONABLE LATCHING TAB AND PLUG CONNECTOR

(71) Applicant: PHOENIX CONTACT GMBH & CO. KG, Blomberg (DE)

(72) Inventor: Ralf GESKE, Schieder-Schwalenberg (DE)

(21) Appl. No.: 18/570,106

(22) PCT Filed: Jun. 13, 2022
(86) PCT No.: PCT/EP2022/065978

§ 371 Date: Apr. 15, 2024

(30) Foreign Application Priority Data
Jun. 17, 2021 (LU) LU500296

(51) Int. Cl. H01R 13/627; H01R 13/508

(52) U.S. Cl. CPC H01R 13/6275; H01R 13/508

(57) ABSTRACT

A latching tab for locking an electrical plug connection between a plug connector and a mating plug connector in a plug-in direction includes: at least one latching clip for resiliently forming a detachable latching connection with a latching portion of the mating plug connector and extending at least partly in a first direction; at least one plug portion for forming a plug connection with a retaining portion of the plug connector, the at least one plug portion extending at least partly in a second direction; and at least one actuating portion for actuating the at least one latching clip. The latching tab transfers the at least one latching clip from a latching position into a release position by actuation of the actuating portion in at least one direction from the first direction and the second direction.

### CROSS-REFERENCE TO PRIOR APPLICATIONS

This application is a U.S. National Phase application under 35 U.S.C. § 371 of International Application No. PCT/EP2022/065978, filed on Jun. 13, 2022, and claims benefit to Luxembourg Patent Application No. LU 500296, filed on Jun. 17, 2021. The International Application was published in German on Dec. 22, 2022 as WO/2022/263351 under PCT Article 21(2).

### FIELD

The present invention relates to a latching tab for locking an electrical plug connection between a plug connector, preferably a series plug connector, and a mating plug connector, preferably a series mating plug connector, in a plug-in direction. The present invention also relates to a plug connector and an arrangement comprising a plug connector, a latching tab, and a mating plug connector.

### BACKGROUND

Plug connectors with locking mechanisms using latching elements in the form of latching levers or latching tabs are known from the prior art in a wide variety of designs and configurations.

A series plug connector having a plurality of plug contacts is known from the German disclosure document DE 10 2020 110 979 A1. With regard to the corresponding plug contact, the housing of the series plug connector comprises a receiving groove with an undercut for receiving, with a positive fit, and a functional element for securing a plug connection with a mating plug connector.

A plug connector for a base housing is known from the German disclosure document DE 10 2010 017 262 B4. A rocker-type locking lever, i.e. latching hooks with latching projections, is used to releasably lock the connection plug to the base housing.

For further prior art, reference is made to CN 110994265 A, US 2019/0280403 A1, DE 10 2017 124 670 A1, EP 3 462 546 B1, EP 3 389 149 A1, DE 10 2014 115 252 A1, DE 20 2009 002 159 U1, and DE 20 2007 005 300 U1, which describe correspondingly designed, integrated latching hooks for securing or locking a plug connection.

The plug connectors and their latching elements known from the prior art are only designed for a specific application. However, these standardly provided latching devices are not sufficient for special cases if, for example, a more robust securing or locking of the plug connection would be desirable or required. Complex modified designs or extensions are then often necessary, which also entails changes to the manufacturing tools, for example injection molding tools.

### SUMMARY

In an embodiment, the present invention provides a latching tab for locking an electrical plug connection between a plug connector and a mating plug connector in a plug-in direction, comprising: at least one latching clip resiliently configured to form a detachable latching connection with a latching portion of the mating plug connector and extending at least partly in a first direction; at least one plug portion configured to form a plug connection with a retaining portion of the plug connector, the at least one plug portion extending at least partly in a second direction; and at least one actuating portion configured to actuate the at least one latching clip, and wherein the latching tab is configured to transfer the at least one latching clip from a latching position into a release position by actuation of the actuating portion in at least one direction from the first direction and the second direction.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1a shows a perspective view of an exemplary embodiment of a latching tab according to the present invention;

FIG. 1b shows a side view of the latching tab shown in FIG. 1a;

FIG. 2a shows a perspective view of the latching tab shown in FIGS. 1a and 1b with an exemplary embodiment of a first housing part of a housing of a plug connector according to the present invention;

FIG. 2b shows a perspective view of the latching tab shown in FIG. 2a and of the first housing part shown in FIG. 2a of the housing of the plug connector in an assembled state;

FIG. 3a shows a perspective view of the first housing part of the housing of the plug connector shown in FIG. 2b with the assembled latching tab and a second housing part of the housing of the plug connector in an exploded view;

FIG. 3b shows a perspective view of the first housing part of the plug connector shown in FIG. 3a with the mounted latching tab and the second housing part of the housing of the plug connector in an assembled state;

FIG. 4a shows a front view of the latching tab shown in FIG. 3a with the first and

the second housing part of the housing of the plug connector;

FIG. 4b shows a sectional view (section A-A in FIG. 4a) of the first and second housing part of the housing of the plug connector, shown in FIG. 4a, with the latching tab,

FIG. 5a shows a front view of the latching tab shown in FIG. 3b with the first and the second housing part of the housing of the plug connector;

FIG. 5b shows a sectional view (section B-B in FIG. 5a) of the first and second housing part, shown in FIG. 5a, of the housing of the plug connector with the latching tab,

FIG. 6a shows a perspective view of an exemplary embodiment of a mating plug connector for producing an electrical plug connection with the plug connector with a latching tab shown in FIGS. 5a and 5b;

FIG. 6b shows a perspective view of an arrangement with the mating plug connector shown in FIG. 6a and the plug connector shown in FIG. 3b with the latching tab,

FIG. 7a shows a front view of the arrangement depicted in FIG. 6b;

FIG. 7b shows a sectional view (section C-C in FIG. 7a) of the arrangement shown in FIG. 7a;

FIG. 8 shows a perspective view of the plug connector shown in FIG. 3b with two further exemplary embodiments of a latching tab according to the present invention.

### DETAILED DESCRIPTION

In an embodiment, the present invention provides an improved latching tab for locking an electrical plug connection and an improved plug connector, which are characterized above all by simple assembly and simplified handling. In addition, the plug connector is characterized by being able to receive differently configured or designed latching tabs for different applications. In an embodiment, the invention provides an arrangement with a plug connector, a mating plug connector and a latching tab.

According to a first general aspect, the invention relates to a latching tab for locking an electrical plug connection between a plug connector, preferably a series plug connector, and a mating plug connector, preferably a series mating plug connector, in a plug-in direction, wherein the latching tab has at least one latching clip which is resiliently configured to form a detachable latching connection with a latching portion of the mating plug connector and extends at least in portions in a first direction, preferably substantially in the plug-in direction, wherein the latching tab has at least one plug portion for forming a plug connection with a retaining portion of the plug connector and the at least one plug portion extends at least in portions in a second direction, preferably substantially perpendicular to the first direction, wherein the latching tab has at least one actuating portion for actuating the at least one latching clip, and the latching tab is configured to transfer the at least one latching clip from a latching position into a release position by actuating the actuating portion in at least one direction from the first direction and the second direction, in order to preferably release the electrical plug connection between the plug connector and the mating plug connector.

With the present invention, a latching tab can be provided that can be expanded in a modular manner relatively simply. As with a spring element, components or elements of the latching tab can change their position relative to each other by actuating the actuating portion.

It is possible for the latching tab with a plurality of latching clips and a plurality of plug portions to have only one single actuating portion. Thus, when the single actuating portion is actuated, all the latching clips of the latching tab can be actuated simultaneously.

According to a further aspect of the invention, it can be provided that the latching tab is substantially L-shaped in a view, preferably in a side view, at least in portions. This makes it relatively easy to produce the latching tab as a resilient element, for example.

It is possible for the at least one latching clip, in a view, preferably in a side view, to be substantially U-shaped or fork-shaped at least in portions and to have a first clip leg and a second clip leg, wherein the first clip leg is arranged at a distance from and/or opposite the second clip leg, wherein the first clip leg is preferably connected to the second clip leg via a web, preferably a common web.

According to a further aspect of the invention, it can be provided that the at least one latching clip merges into the at least one actuating portion and/or into the at least one plug portion.

A relatively compact design of the latching tab can thereby be ensured, for example.

It is possible for the at least one plug portion to be substantially plate-shaped and/or to have a substantially trapezoidal or substantially wedge-shaped contour in a view, preferably in a cross-sectional view.

According to a further aspect of the invention, it can be provided that the at least one actuating portion has, in a view, preferably in a side view, an essentially L-shaped contour at least in portions, and/or that the at least one actuating portion is substantially plate-shaped at least in portions.

It is possible for at least one stop element to be arranged between the at least one actuating portion and the at least one plug portion.

It is possible for at least one stop element to be substantially plate-shaped or bolt-shaped at least in portions, and/or to extend substantially in the first direction.

According to a further aspect of the invention, it can be provided that the at least one latching clip for forming the detachable latching connection comprises a latching element, preferably in each case only a single latching element, wherein the latching element is preferably designed as a latching projection, for example in the shape of a wedge.

It is possible for the at least one latching clip and the at least one plug portion and the at least one actuating portion to be formed integrally in one piece, preferably by at least one casting process and/or by at least one injection molding process, or as a stamped/bent part.

According to a second general aspect, the invention relates to a plug connector, preferably a series plug connector, having at least one plug contact for forming an electrical plug connection with at least one mating plug contact of a mating plug connector, preferably a series mating connector, in a plug-in direction, wherein the at least one plug contact extends from an end wall of the housing of the plug connector in the plug-in direction, wherein the end wall has at least one retaining portion for forming a positive connection, preferably a plug connection, with at least one latching tab, preferably with at least one latching tab as disclosed herein, wherein the at least one retaining portion is configured to clamp the at least one latching tab with a clamping element of the retaining portion at least during the forming of the positive connection with the at least one latching tab.

As a result, for example the at least one latching tab can be securely arranged on the plug connector. Furthermore, a plurality of latching tabs, preferably two latching tabs, of different design or configuration can be arranged on the plug connector.

According to a further aspect of the invention, it can be provided that the at least one retaining portion is formed at least in portions within the end wall and/or extends at least in portions substantially perpendicular to the plug-in direction.

It is possible for the clamping element to be arranged within the at least one retaining portion and for it to preferably extend at least in portions substantially perpendicular to the plug-in direction.

According to a further aspect of the invention, it can be provided that the at least one retaining portion has at least one stop for the at least one latching tab.

According to a further aspect of the invention, it can be provided that the at least one retaining portion has, in a view, preferably along its extension, a substantially trapezoidal contour or a substantially wedge-shaped contour at least in portions for forming the positive connection, wherein the clamping element preferably has, in this view, a substantially semicircular contour or a substantially semi-oval contour.

It is possible for the end wall to have at least one guide channel for guiding a stop element of the at least one latching tab, wherein the at least one guide channel extends away from the at least one retaining portion substantially perpendicular to the plug-in direction along the end wall.

According to a further aspect of the invention, it can be provided that the at least one guide channel has a greater depth in the plug-in direction than the at least one retaining portion in the plug-in direction and/or the at least one retaining portion merges into the at least one guide channel.

According to a further aspect of the invention, it can be provided that the housing has a first housing part and a second housing part for forming a housing plug connection in the plug-in direction.

The first housing part can comprise at least the end wall with the at least one guide channel, wherein the at least one guide channel is delimited at least in portions by a wall portion of the second housing part extending substantially in the plug-in direction when the housing plug connection is formed.

It is possible for the at least one plug contact to have a substantially square-shaped (square) contour or a substantially rectangular contour in a view, preferably in the plug-in direction, and/or for the end wall to have a substantially rectangular contour in a view, preferably in the plug-in direction.

According to a third general aspect, the invention relates to an arrangement comprising at least one latching tab as disclosed herein, a plug connector, preferably a series plug connector, as disclosed herein, and a mating plug connector, preferably a series mating plug connector, as disclosed herein, wherein the mating plug connector is configured to form an electrical plug connection with the plug connector.

Identical or functionally equivalent components or elements are denoted by the same reference signs in Figures. For the explanation thereof, reference is also made in part to the description of other exemplary embodiments and/or Figures in order to avoid repetitions.

The following detailed description of the exemplary embodiments illustrated in the figures serves for more detailed illustration or clarification and is not intended to limit the scope of the present invention in any way.

In the figures, double-headed arrows indicate a first direction X1, a second direction X2, and a plug-in direction X. The first direction X1 and the second direction X2 relate in particular to the latching tab shown. The plug-in direction X is preferably the direction for forming an electrical plug connection between the plug connector and the mating plug connector. Preferably, the first direction X1 is parallel to the plug-in direction X. Preferably, the second direction X2 is perpendicular to the first direction X1.

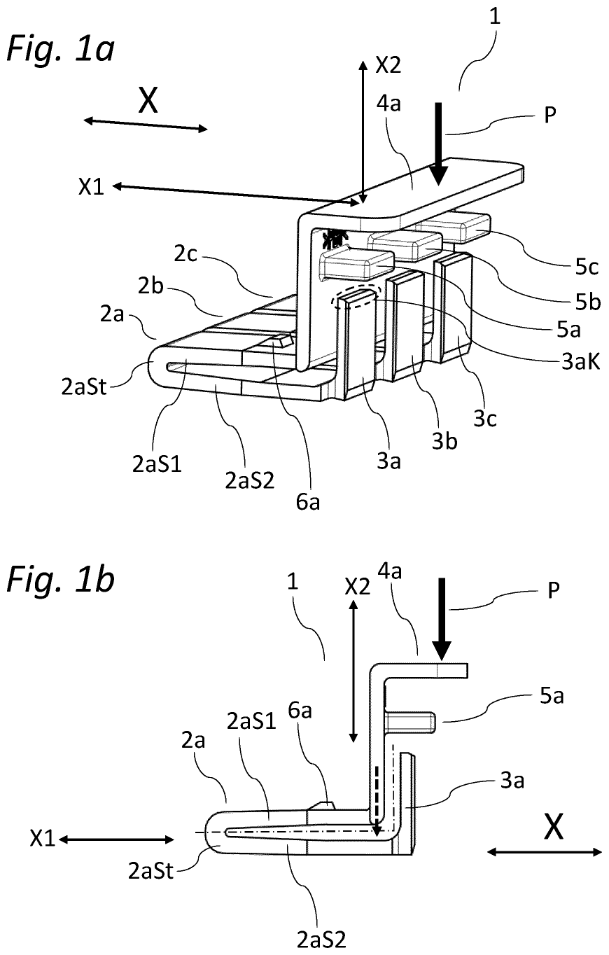

FIG. 1a shows a perspective view of an exemplary embodiment of a latching tab 1 according to the present invention.

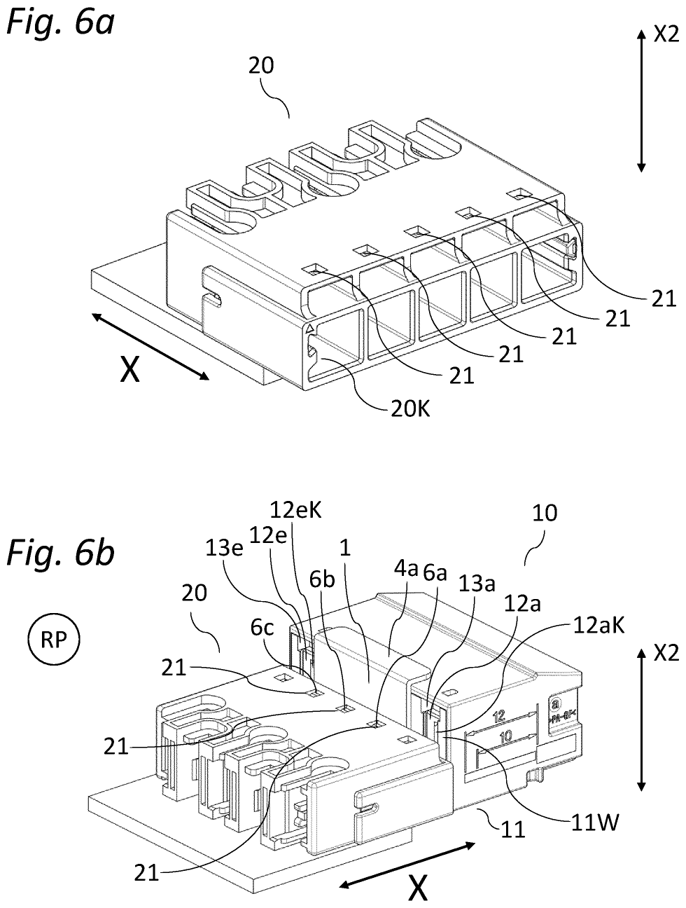

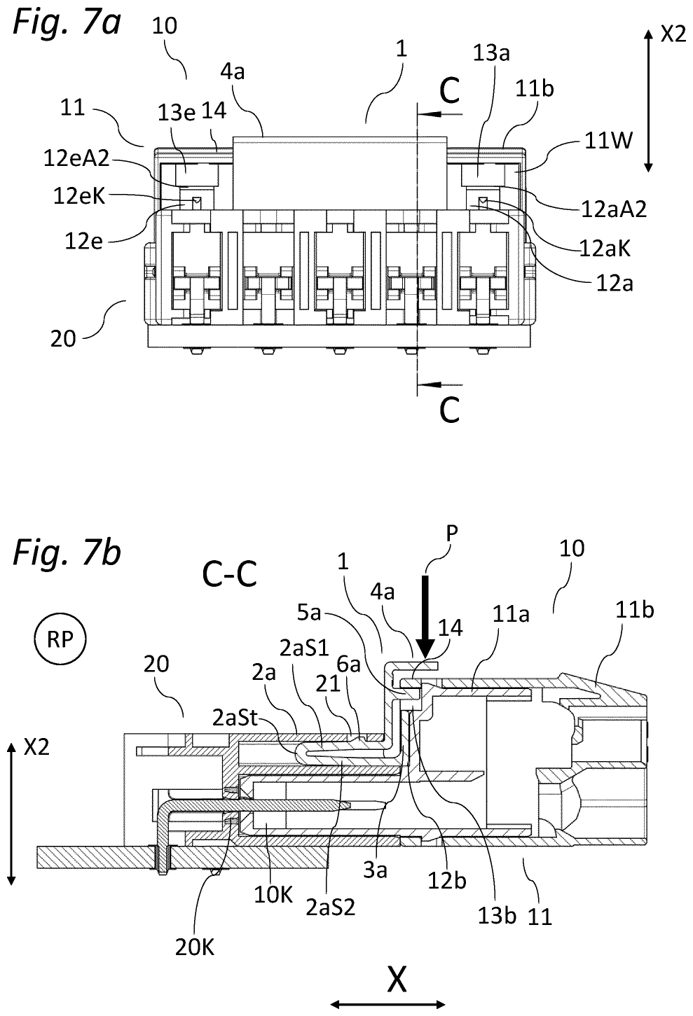

The latching tab 1 is used to lock an electrical plug connection between a plug connector 10 and a mating plug connector 20 in a plug-in direction X (see the further FIGS. 6b to 7b). The latching tab 1 has three latching clips 2a, 2b, 2c. The three latching clips 2a, 2b, 2c are resiliently configured and/or designed to form a detachable latching connection with a respective latching portion 21 of the mating plug connector 20 (see the further FIGS. 6a to 7b), and are described in more detail below.

The three latching clips 2a, 2b, 2c each have a first clip leg and a second clip leg, of which the first clip leg 2aS1 and the second clip leg 2aS2 of the latching clip 2a are shown and identified in FIG. 1a. The first clip leg 2aS1 of the latching clip 2a is connected to the second clip leg 2aS2 of the latching clip 2a via a common web 2aSt. Both the first clip leg 2aS1 and the second clip leg 2aS2 are substantially plate-shaped and/or flat and extend in or along a first direction X1. The first clip leg 2aS1 comprises a latching element 6a in the form of a wedge-shaped projection. The latching element 6a is arranged on the first clip leg 2aS1 on the side of the first clip leg 2aS1 of the latching clip 2a facing away from the second clip leg 2aS2. The latching element 6a is preferably integrally formed in one piece with at least the first clip leg 2aS1. When the electrical plug connection is formed, the latching element 6a engages in the latching portion 21 of the mating plug connector 20, which is preferably designed as a recess, and thus releasably locks the electrical plug connection at least in the plug-in direction X. Due to the resilient design, the two clip legs 2aS1 and 2aS2 can be reversibly and/or elastically compressed, preferably in the second direction X2. The latching clip 2a and also the further latching clips 2b and 2c are thus configured and/or designed as spring elements. The reversible deformability of the two bracket legs 2aS1 and 2aS2 relative to each other is accompanied by a change in the position of the latching element 6a on the first bracket leg 2aS1 when the latching tab 1 is correspondingly actuated. This is described in more detail below. Analogously to the latching clip 2a, this and the other properties described for the latching clip 2a also apply to the other latching clips 2b and 2c of the latching tab 1. The same preferably also applies for further components or elements of the latching tab 1.

The latching clip 2a and also the further latching clips 2b and 2c each have at least one plug portion 3a, 3b, and 3c for forming a corresponding plug connection with a corresponding retaining portion 12a to 12e of the plug connector 10 (see the further figures). The plug connection between the latching tab 1 and the plug connector 10 can preferably be a detachable and/or positive plug connection.

The plug portions 3a, 3b, 3c are each substantially plate-shaped and/or flat and extend in the second direction X2, which is preferably perpendicular to the first direction X1 and/or perpendicular to the plug-in direction X. With reference to the latching clip 2a, it can be seen from FIG. 1a that the associated plug portion 3a adjoins the second clip leg 2aS2 and is arranged more or less perpendicular or substantially perpendicular to the second clip leg 2aS2. In other words, the second clip leg 2aS2 merges into the plug portion 3a. The second clip leg 2aS2 can be integrally formed in one piece with the plug portion 3a.

In a view, preferably in the second direction X2, the plug portion 3a has a substantially trapezoidal or substantially wedge-shaped contour 3aK, which serves to form the plug connection with the corresponding retaining portion 12a to 12e of the plug connector 10 in order in this way to arrange the latching tab 1 on the plug connector 10, preferably to detachably fasten it. The retaining portion 12a to 12e of the plug connector 10 has a contour that is substantially identical or at least similar to the contour 3aK of the plug portion 3a, so that the plug connection can be formed. The plug connection can thus be a dovetail connection, for example.

The latching clips 2a, 2b, 2c are connected to one another via a common wall portion of the latching tab 1. The common wall portion is substantially plate-shaped and/or flat and extends substantially in the second direction X2, preferably substantially perpendicular to the first direction X1 or substantially perpendicular to the plug-in direction X. In an initial state, i.e. in an unloaded state of the latching tab 1, the common wall portion is arranged and/or aligned more or less parallel to the plate-shaped plug portions 3a, 3b, 3c (see also FIG. 1b).

The actuation of the latching tab 1 and thus a compression of the first and the second clip legs 2aS1 and 2aS2 of the latching clip 2a and the further latching clips 2b and 2c relative to one another is done by applying a force to the actuating portion 4a. The force is preferably a pressure force P. The actuating portion 4a is preferably substantially plate-shaped and/or flat, at least in portions, and has a substantially rectangular contour in a view, preferably in a plan view, so that it can be easily operated by hand.

The actuating portion 4a can be actuated by applying a pressure force P in the second direction X2. Additionally or alternatively, it is also possible to apply a pressure force (not shown in FIG. 1a) to the common wall portion at least partially in the first direction X1 in order to achieve a compression of the first actuating leg(s) 2aS1 relative to the second actuating leg(s) 2aS2. In other words, the latching tab 1 as a whole is configured as a compressible spring element made of a flat material.

FIG. 1b shows a side view of the latching tab 1 shown in FIG. 1a. It can be seen from FIG. 1b that the latching tab 1 is substantially L-shaped at least in portions or has a substantially L-shaped configuration at least in portions. This applies, for example, to the arrangement of the first clip leg 2aS1 and of the second clip leg 2aS2 of the latching clip 2a and thus of the corresponding further clip legs of the further latching clips 2b and 2c to the plug portion 3a and thus to the further plug portions 3b and 3c. From the side view in FIG. 1b, it can also be seen that the latching clip 2a is designed to be substantially U-shaped or substantially fork-shaped at least in portions, according to which the first clip leg 2aS1 is arranged at a distance from and/or opposite the second clip leg 2aS2. This also applies to the configuration of the further latching clips 2b and 2c. As already described above, the first clip leg 2aS1 is connected to the second clip leg 2aS2 via the (common) web 2aSt. The first clip leg 2aS1 of the latching clip 2a merges into the actuating portion 4a and the second clip leg 2aS2 of the latching clip 2a merges into the plug portion 3a.

In this view, i.e. in a side view, the actuating portion 4a has a substantially L-shaped contour at least in portions. A plate-shaped stop element 5a, 5b and 5c, which extends in each case at least in portions in the first direction X1, preferably in the plug-in direction X, is arranged between the actuating portion 4a and the plug portion 3a and the further plug portions 3b and 3c. The stop element 5a or the stop elements 5a, 5b, 5c as a whole can serve to guide the actuating portion 4a during an actuation if the latching tab 1 forms a plug-in connection with plug connector 10.

Preferably, the latching tab 1 can be integrally formed in one piece as a whole, for example by at least one injection process and/or by at least one casting process with a plastics material having corresponding elasticity and/or reversible deformation properties.

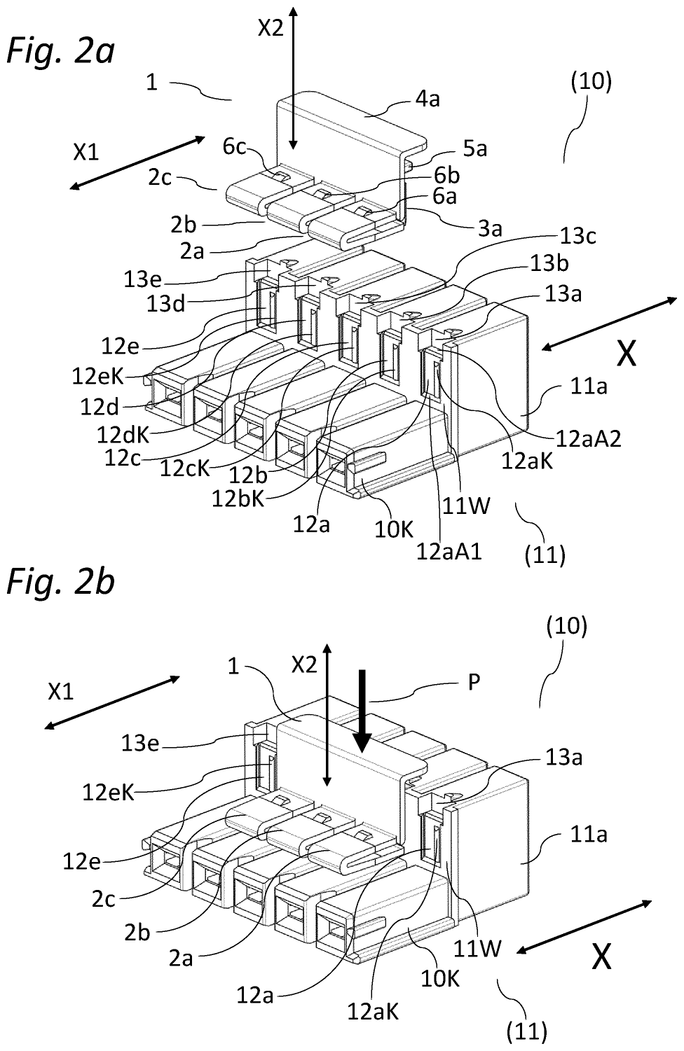

FIG. 2a is a perspective view of the latching tab 1 shown in FIGS. 1a and 1b, with an exemplary embodiment of a first housing part 11a of a housing 11 for a plug connector 10 according to the present invention.

The plug connector 10 is preferably designed as a series plug connector and comprises five plug-in contacts 10K arranged in series, of which one plug-in contact 10K is marked accordingly in FIG. 2a. The plug connector 10 has, at least in portions, a substantially cuboid design. The plug contact 10K and thus the further plug contacts extend in the plug-in direction X from an end wall 11W of the first housing part 11a. For example, corresponding contact elements for establishing an electrically conductive connection to an electrical conductor are provided within the plug contact 10K. The plug contact 10K and the further plug contacts are not described in more detail herein.

The end wall 11W of the first housing part 11a has five retaining portions 12a to 12e which extend, among other things, in the second direction X2, away from the plug contacts 10K. The retaining portions 12a to 12e are used to form at least one positive connection, i.e. a detachable plug connection with the plug portions 3a, 3b, 3c of the latching tab 1. For this purpose, the retaining portions 12a to 12e, in a view along their extension, have identical or at least similar contours, which are trapezoidal at least in portions or wedge-shaped at least in portions, substantially perpendicular to the plug-in direction X corresponding to the plug portions 3a, 3b, 3c of the latching tab 1. This allows the so-called dovetail joints mentioned above to be formed.

The retaining portions 12a to 12e are configured and/or designed to clamp the latching tab 1 with clamping elements 12aK to 12eK, at least during the forming of the positive connection to the latching tab 1. This ensures, for example, an optimized detachable but nevertheless permanent fastening of the latching tab 1 to the plug connector 10. In this way, the latching tab 1 can be securely arranged on the plug connector 10, for example, and unintentional detachment of the latching tab 1 from the plug connector 10 before an electrical plug connection with a mating plug connector 20 is formed can thus be avoided.

The clamping elements 12aK to 12eK are preferably arranged within the retaining portions 12a to 12e and extend at least in portions substantially perpendicular to the plug-in direction X. In a view in the second direction X2, the clamping elements 12aK to 12eK have a substantially semicircular contour. It is also possible for the clamping elements 2aK to 12eK to have a substantially semi-oval contour in a view in the second direction X2. In other words, the clamping elements 12aK to 12eK can be arranged as cylindrical pins in the retaining portions 12a to 12e in the direction of their extension in each case. When the plug connection is formed with the plug portions 3a, 3b, 3c of the latching tab 1, the clamping elements 12aK to 12eK exert a corresponding clamping force on the latching tab 1. The latching tab 1 is thus not only positively detachably fastened to the plug connector 10, but also non-positively detachably attached to the plug connector 10.

Furthermore, each of the retaining portions 12a to 12e comprises a first stop and a second stop, of which the first stop 12aA1 and the second stop 12aA2 of the retaining portion 12a are identified in FIG. 2a. The first stop 12aA1 or the second stop 12aA2 can be used for the final positioning of the latching tab 1 on the plug connector 10 via corresponding contacting with walls and/or wall portions of the latching tab 1.

The end wall 11W also has guide channels 13a to 13e, which are each designed to receive and/or guide a stop element 5a, 5b, 5c of the latching tab 1. The guide channels 13a to 13e extend at least substantially perpendicular to the plug-in direction X along the end wall 11W, away from the retaining portions 12a to 12e.

In the plug-in direction X, the guide channels 13a to 13e have a greater depth than the retaining portions 12a to 12e. The retaining portions 12a to 12e merge into the guide channels 13a to 13e.

FIG. 2b is a perspective view of the latching tab 1 shown in FIG. 2a and of the first housing part 11a of the plug connector 10 shown in FIG. 2a in an assembled state. In other words, the latching tab 1 is correspondingly positively and non-positively fastened to the retaining portions 12b, 12c, and 12d (see FIG. 2a) via the plug portions 3a, 3b, 3c. The latching tab 1 is now supported or mounted on the plug connector 10, i.e. on the first housing part 11a, and can be actuated by applying a pressure force P in the second direction X2, so that a reversible deformation takes place in the region of the resilient latching clips 2a, 2b, 2c.

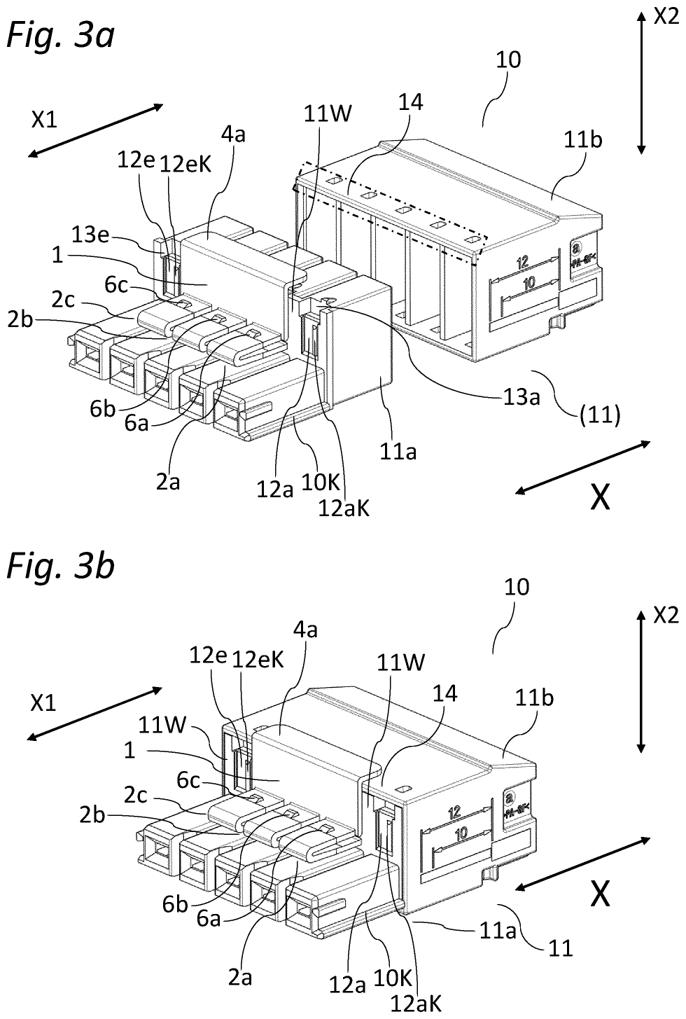

FIG. 3a is a perspective view of the first housing part 11a of the plug connector 10 shown in FIG. 2b with the mounted latching tab 1, and of a second housing part 11b of the housing 11 of the plug connector 10, in an exploded view. The second housing part 11b is configured so as to form, with the first housing part 11a, a plug connection in the plug-in direction X to form the housing 11 of the plug connector 10. The second housing part 11b can furthermore preferably form at least one latching connection with the first housing part 11a. The second housing part 11b can, for example, accommodate at least connection elements, preferably push-out elements from push-in technology, with corresponding spring clamps and actuating elements for releasing the spring clamps.

FIG. 3b is a perspective view of the first housing part 11a of the plug connector 10 shown in FIG. 3a with the assembled latching tab 1 and of the second housing part 11b of the housing 11 of the plug connector 10 in an assembled state.

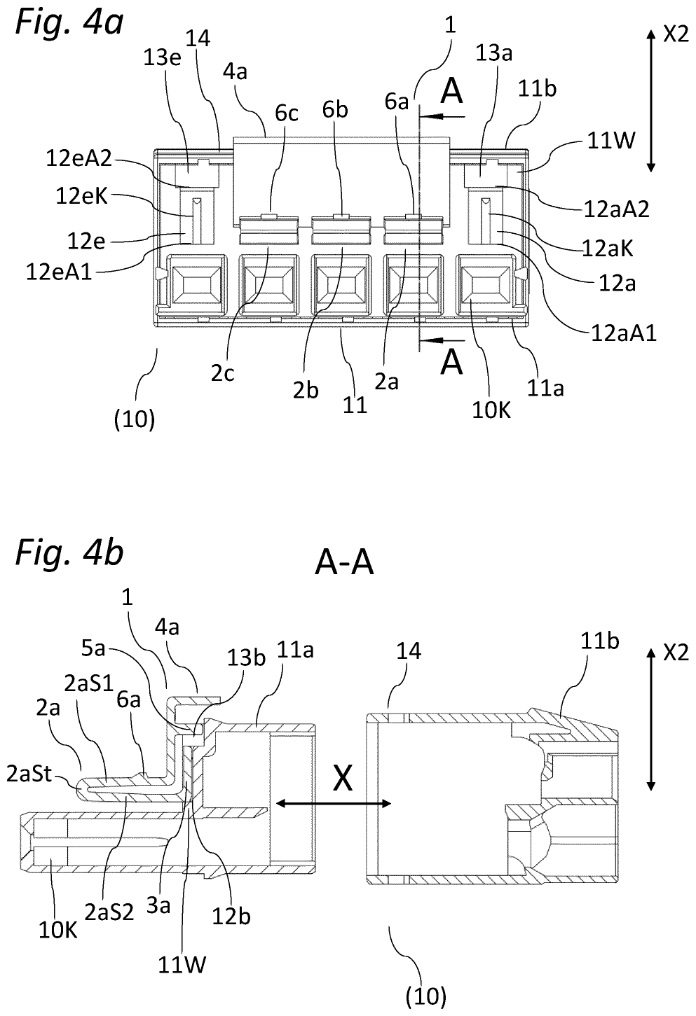

FIG. 4a shows a front view of the latching tab 1 shown in FIG. 3a with the first and the second housing part 11a, 11b of the housing 11 of the plug connector 10. In this view, the housing 11 of the plug connector 10 has a substantially rectangular contour. Likewise, the plug contacts 10K have a substantially rectangular contour in this view. The plug contacts 10K are arranged in a row in a direction running transversely to the plug-in direction X and thus form the plug connector 10 in the form of a series plug connector.

FIG. 4b shows a sectional view (section A-A in FIG. 4a) of the first and second housing part 11a, 11b shown in FIG. 4a of the housing 11 of the plug connector 10 with the latching tab 1. The visible plug portion 3a of the latching tab 1 is accommodated in the visible retaining portion 12b of the first housing part 11a of the plug connector 10 with a positive fit, in a direction running transversely to the plug-in direction X, i.e. in the second direction X2.

The visible stop element 5a of the latching tab 1 is received at least in portions in the visible guide channel 13b of the end wall 11W. The latching tab 1 is supported on the first housing part 11a and can be actuated via the actuating portion 4a. The stop element 5b and further, non-visible stop elements 5a and 5c are guided along the guide channels 13b, 13c, and 13d, so that the latching tab 1 can carry out a defined spring-elastic, i.e. reversible deformation, upon actuation in order in particular to change the position of the latching element 6a or the latching elements 6a, 6b, 6c.

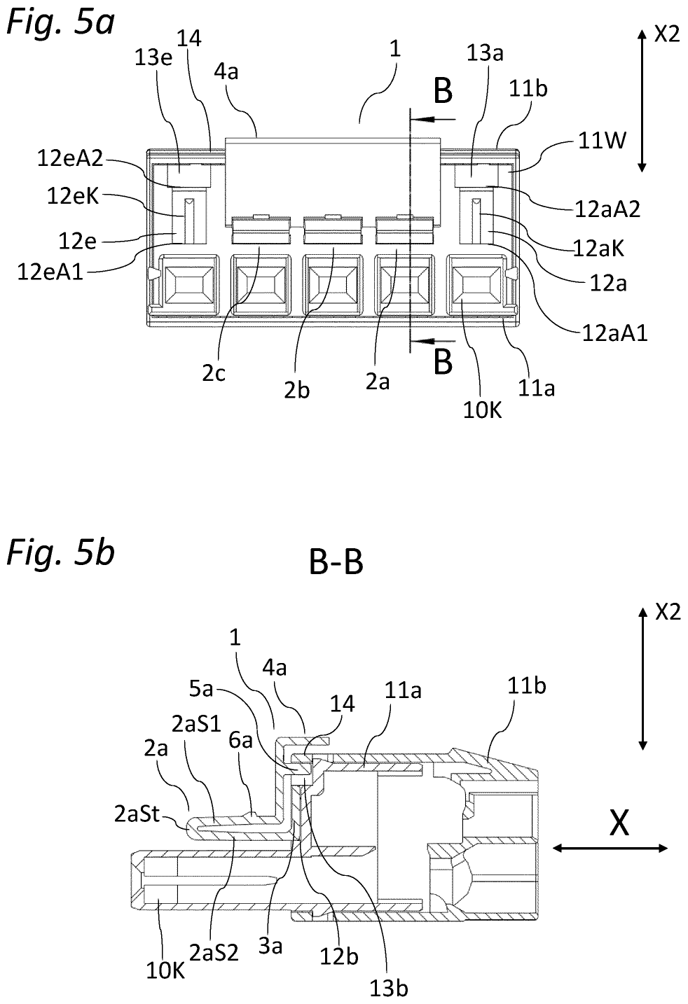

FIG. 5a shows a front view of the latching tab 1 shown in FIG. 3b with the first and the second housing part 11a, 11b of the housing 11 of the plug connector 10 in an assembled state.

FIG. 5b shows a sectional view (section B-B in FIG. 5a) of the first and second housing parts 11a, 11b, shown in FIG. 5a, of the housing 11 of the plug connector 10 with the latching tab 1.

In the representations in FIGS. 5a and 5b, compared to the representation in FIGS. 4a and 4b, it is shown that the second housing part 11b is completely plugged together with the first housing part 11a and a housing plug connection and also latching connections are formed. The outer wall portion 14 of the second housing part 11b extending in the plug-in direction X limits the guide channels 13a to 13e in their extension in the second direction X2, which is clearly shown for the guide channel 13b in FIG. 5b.

FIG. 6a shows a perspective view of an embodiment of a mating plug connector 20 for producing an electrical plug connection with the plug connector 10 shown in FIGS. 5a and 5b with the latching tab 1.

Of the five mating plug contacts 20K of the mating plug connector 20, one mating plug contact 20K is marked accordingly in FIG. 6a. The five mating plug contacts 20K are designed corresponding to the plug contacts 10K of the plug connector 10 in order to be able to form an electrical plug connection in the plug-in direction X. The housing of the mating plug connector 20 can be produced analogously to the housing 11 of the plug connector 10.

The mating plug connector 20 comprises correspondingly arranged latching portions 21 in the form of recesses or holes, preferably rectangular in cross-section, on a corresponding outer wall. The latching portions 21 are used to form a detachable latching connection with a respective latching element 6a, 6b, 6c of the latching clips 2a, 2b, 2c of the latching tab 1 when the mating plug connector 20 forms an electrical plug connection with the plug connector 10.

FIG. 6b now shows a perspective view of an arrangement with the mating plug connector 20 shown in FIG. 6a and the plug connector 10 shown in FIG. 3b with the latching tab 1.

The plug connector 10 here forms the electrical plug connection together with the mating plug connector 20. The latching elements 6a, 6b, 6c of the latching clips 2a, 2b, 2c of the latching tab 1 now engage in the corresponding latching portions 21 of the mating plug connector 20 and thus lock the electrical plug-in connection. FIG. 6b thus shows the electrical plug connection in a latching position RP.

FIG. 7a shows a front view of the arrangement shown in FIG. 6b and FIG. 7b shows a sectional view (section C-C in FIG. 7a) of the arrangement shown in FIG. 7a. FIG. 7b clearly shows the locking of the electrical plug connection with the visible latching element 6a, which engages in the visible latching portion 21.

By applying a pressure force P in the second direction X2, i.e. toward the housing 11 of the plug connector 10, the locked electrical plug connection can be unlocked again via the latching tab 1.

By applying the pressure force P to the actuating portion 4a, at least a portion of the latching tab 1 is reversibly deformed, after which the visible first clip leg 2aS1 moves with the latching element 6a of the latching clip 2a toward the second clip leg 2aS2.

The latching element 6a is disengaged with respect to the latching portion 21 of the mating plug connector 20 and thus releases the mating plug connector 20. The mating plug connector 20 can then be pulled off the plug connector 10 in the plug-in direction X without great application of force. After removal of the pressure force P, the reversibly deformed latching tab 1 then returns to its originally assumed shape until the stop element 5a makes contact in the guide channel 13b, if necessary with the inner surface of the outer wall portion 14 of the second housing part 11b.

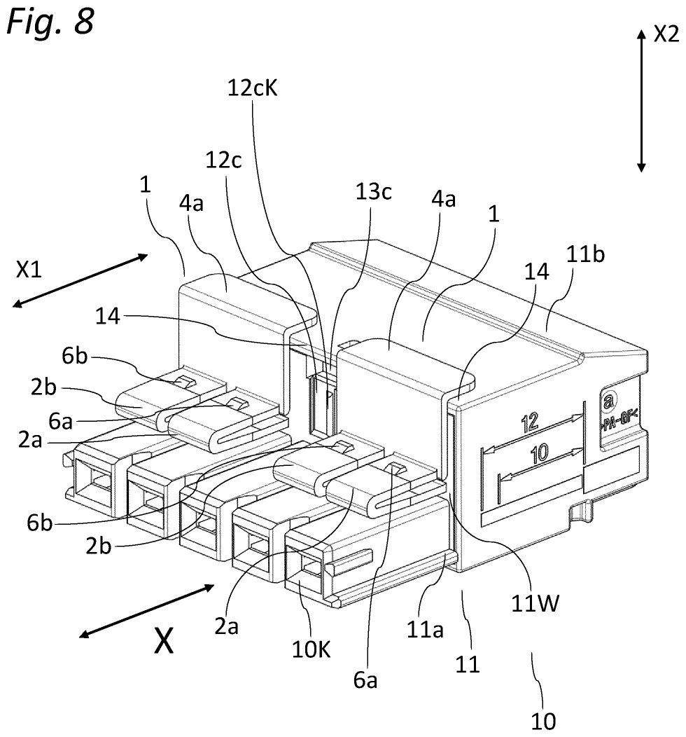

FIG. 8 shows a perspective view of the plug connector 10 shown in FIG. 3b with two latching tabs 1 on the housing 11, i.e. on corresponding retaining portions 12a, 12b, and 12d, 12e (not visible in FIG. 8). According to a further embodiment, the latching tabs 1 are designed according to the present invention. The two latching tabs 1 each comprise two latching clips 2a, 2b, each having a latching element 6a, 6b. With regard to their arrangement, the latching tabs 1 are located on the two outer retaining portions 12a, 12b and 12d, 12e of the total of five retaining portions 12a to 12e on the first housing part 11a of the housing 11 of the plug connector 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Latching tab
2a, 2b, 2c Latching clip
2aS1 First clip leg
2aS2 Second clip leg
2aSt Web
3a, 3b, 3c Plug portion
4a Actuating portion
5a, 5b, 5c Stop element
6a, 6b, 6c Latching element
10 Plug connector
11 Housing
11a, 11b Housing part
11W End wall
12a, . . . , 12e Retaining portion
12aK, . . . , 12eK Clamping element
13a, . . . , 13e Guide channel
14 Outer wall portion
20 Mating plug connector
20K Mating plug connector contact
21 Latching portion
P Compressive force
RP Latching position
X longitudinal direction
X1 First direction
X2 Second direction

1. A latching tab for locking an electrical plug connection between a plug connector and a mating plug connector in a plug-in direction, comprising:
at least one latching clip resiliently configured to form a detachable latching connection with a latching portion of the mating plug connector and extending at least partly in a first direction;
at least one plug portion configured to form a plug connection with a retaining portion of the plug connector, the at least one plug portion extending at least partly in a second direction; and
at least one actuating portion configured to actuate the at least one latching clip, and
wherein the latching tab is configured to transfer the at least one latching clip from a latching position into a release position by actuation of the actuating portion in at least one direction from the first direction and the second direction.

2. The latching tab of claim 1,
wherein the latching tab is L-shaped at least in portions in a view.

3. The latching tab of claim 1,
wherein the at least one latching clip is U-shaped or fork-shaped at least in portions in a view, and has a first clip leg and a second clip leg, and
wherein the first clip leg is arranged at a distance from and/or opposite the second clip leg.

4. The latching tab of claim 1,
wherein the at least one latching clip merges into the at least one actuating portion and/or into the at least one plug portion.

5. The latching tab of claim 1,
wherein the at least one plug portion is plate-shaped and/or has a trapezoidal or wedge-shaped contour in a view.

6. The latching tab of claim 1,
wherein the at least one actuating portion has an L-shaped contour at least in portions in a view, and/or the at least one actuating portion is plate-shaped at least in portions.

7. The latching tab of claim 1,
wherein at least one stop element is arranged between the at least one actuating portion and the at least one plug portion.

8. The latching tab of claim 7,
wherein the at least one stop element is plate-shaped or bolt-shaped at least in portions, and/or extends in the first direction.

9. The latching tab of claim 1,
wherein the at least one latching clip comprises a latching element.

10. The latching tab of claim 1,
wherein the at least one latching clip and the at least one plug portion and the at least one actuating portion are integrally formed in one piece, or as a stamped/bent part.

11. A plug connector, comprising:
at least one plug-in contact configured to form an electrical plug connection with at least one mating plug-in contact of a mating plug connector in a plug-in direction,
wherein the at least one plug-in contact extends from an end wall of a housing of the plug connector in the plug-in direction,
wherein the end wall has at least one retaining portion configured to form a positive connection with the at least one latching tab of claim 1, and
wherein the at least one retaining portion is configured to clamp the at least one latching tab with a clamping element of the retaining portion at least when forming the positive connection with the at least one latching tab.

12. The plug connector of claim 11,
wherein the at least one retaining portion is formed at least in portions within the end wall and/or extends at least in portions perpendicular to the plug-in direction.

13. The plug connector of claim 11,
wherein the clamping element is arranged within the at least one retaining portion.

14. The plug connector of claim 11,
wherein the at least one retaining portion has at least one stop for the at least one latching tab.

15. The plug connector of claim 11,
wherein the at least one retaining portion has a trapezoidal contour or a wedge-shaped contour in a view, for forming the positive connection, at least in portions.

16. The plug connector of claim 11,
wherein the end wall has at least one guide channel configured to guide a stop element of the at least one latching tab, and
wherein the at least one guide channel extends perpendicularly to the plug-in direction along the end wall from the at least one retaining portion.

17. The plug connector of claim 16,
wherein the at least one guide channel has a greater depth in the plug-in direction than the at least one retaining portion in the plug-in direction and/or the at least one retaining portion merges into the at least one guide channel.

18. The plug connector of claim 16,
wherein the housing has a first housing part and a second housing part configured to form a housing plug connection in the plug-in direction,
wherein the first housing part comprises at least the end wall with the at least one guide channel, and
wherein the at least one guide channel is delimited at least in portions by a wall portion of the second housing part extending in the plug-in direction during the forming of the housing plug connection.

19. The plug connector of claim 11,
wherein the at least one plug contact has a square-shaped contour or a rectangular contour in a view, and/or the end wall has a rectangular contour in a view.

20. An arrangement: comprising:
at least one latching tab of claim 1;
a plug connector, comprising:
at least one plug-in contact configured to form an electrical plug connection with at least one mating plug-in contact of a mating plug connector in a plug-in direction, and
a mating plug connector,
wherein the at least one plug-in contact extends from an end wall of a housing of the plug connector in the plug-in direction,
wherein the end wall has at least one retaining portion configured to form a positive connection with the at least one latching tab of claim 1,
wherein the at least one retaining portion is configured to clamp the at least one latching tab with a clamping element of the retaining portion at least when forming the positive connection with the at least one latching tab, and
wherein the mating plug connector is configured to form an electrical plug-in connection with the plug connector.
